(19) United States
(12) Patent Application Publication
(10) Pub. No.: US 2017/0304033 A1
(43) Pub. Date: Oct. 26, 2017

(54) FORM FOR PRODUCING A PRE-MOLDED PROSTHESIS-BASE BLANK

(71) Applicant: Heraeus Kulzer GmbH, Hanau (DE)

(72) Inventors: Klaus Ruppert, Maintal (DE); Michael Eck, Schmitten (DE)

(21) Appl. No.: 15/516,061

(22) PCT Filed: Sep. 24, 2015
(86) PCT No.: PCT/EP2015/071980

§ 371 Date: Mar. 31, 2017

(30) Foreign Application Priority Data
Oct. 1, 2014 (DE) 10 2014 114 278.0

(51) Int. Cl. A61C 13/01; A61C 13/00

(52) U.S. Cl. CPC A61C 13/04; A61C 13/0004; A61C 13/0022

(57) ABSTRACT

The invention relates to a form for producing a pre-molded prosthesis base blank, wherein the pre-molded prosthesis base blank is provided for producing a prosthesis base for a dental prosthesis with a subtractive CAM method, wherein the form features an inner surface which is a negative of the prosthesis base blank to be produced, wherein the inner surface features a negative of a dental arch or a dental arch section with a thickening in the occlusal direction, and the form consists of at least two parts, which are affixed in such a manner that are detachable from each other or which are detachably affixable to each other.

The invention also relates to a method for producing a prosthesis base blank with such a form, in which a hot polymer or cold polymer is filled into the at least dual-part compiled form, the hot polymer or cold polymer is then hardened, and as a next step, the parts of the form are detached from the hardened prosthesis base blank. Finally, the invention also relates to a prosthesis base blank.

The invention relates to a form for producing a pre-molded prosthesis base blank, wherein the pre-molded prosthesis base blank is used for the production of a denture base for a dental prosthesis with a subtractive CAM method.

The invention further relates to a method for producing a prosthesis base blank with such a form and a prosthesis base blank produced with such a method or with such a form.

The invention thus ultimately relates to the production of partial synthetic prostheses (partial prostheses) and total synthetic prostheses (total prostheses) for dental medicine, or of prosthesis bases for this purpose, which are produced mechanically using the CAM method (CAM=Computer-Aided Manufacturing). Preferably, the dental prostheses and the prosthesis bases are constructed for this purpose using the CAD method (CAD=Computer-Aided Design). Here, a prosthesis base is first produced which later lies on the toothless or partially toothless gum of the jaw arch of a patient. The prosthetic teeth are then individually produced and inserted into the prosthesis base, where they are affixed. The prosthesis base together with the set prosthetic teeth then forms the complete dental prosthesis.

The standard method is the analogue production of dental prostheses. Thus, in order to produce the prosthesis base, an analogue method is currently usually used, in which at first, an imprint of the toothless jaw of the patient is made. From this imprint, a form is produced which is poured with a gum-colored plastic. Following hardening of the plastic, this is post-processed in order to obtain the desired form. Then, the separately produced prosthetic teeth are inserted, which are also currently usually produced in an analogue manner.

In order to produce the prosthesis, prosthetic teeth are set manually and individually on a wax base. This wax prosthesis is embedded in a cuvette with plaster in the next step, in order to then wash out the wax base with hot water after the plaster has hardened, and create a hollow space for the prosthesis plastic. The prosthetic teeth remain in the plaster during this process. A corresponding prosthesis material is injected or pressed into the hollow space and, following hardening of the plastic, the prosthesis or the finished prosthetic teeth are obtained.

When the pre-fabricated teeth are set, they are adapted and ground by the dental technician and possibly also the dentist to fit the respective mouth situation of the patient.

Such a method is known from WO 91/07141 A1, in which a prosthesis base is milled from a plastic block based on an imprint. First methods, such as those from DE 10 2009 056 752 A1 or WO 2013 124 452 A1, already exist in which the partial or total prosthesis is digitally set and produced using a CAD-CAM method. FR 2 582 932 A1 recommends that a prosthesis base is produced with the aid of a wax imprint and a 3D copy mill, although this method is more complex than the modern CAD-CAM methods. A milling block is known from WO 2013 068 124 A2 with pre-molded prosthetic teeth. The disadvantage here is that the prosthetic teeth consist of the same material as the base, and if damage occurs, the entire set of teeth must be replaced and the pre-constructed prosthesis can only be adapted to the needs of the patient (e.g. with regard to the tooth color or occlusion and tooth position) with a great deal of effort. A further disadvantage is that the base and the prosthetic tooth (or prosthetic tooth crown) have different requirements but are produced from the same material. Thus, the tooth must primarily chew and remain undamaged. At the same time, the base should distribute the forces that arise over the mucous membrane. This can lead to problems if only one material is used.

A round blank for producing a dental prosthesis is known from DE 20 2006 006 286 U1. Such blanks are in principle solid polymethylmethacrylate discs (PMMA discs). This blank (or “round blank”) is tensioned in a CAD milling machine and automatically milled on the basis of a CAD model. Current methods mill a prosthesis base that is only 2 mm to 3 mm thick from such a full block (the round blank). Disadvantages are a very high waste of material on the one hand, which depending on the anatomical situation of the patient in question can by all means exceed 90%. On the other, this leads to a time-intensive processing period by the CAM device, since a great deal of material must be removed. Furthermore, the wear on the milling tool used is relatively high.

A further disadvantage here is that it takes a relatively long time until the prosthesis base has been produced. Additionally, the milling head is subject to wear due to the processing of the blank, and must be renewed at regular intervals. The milled off material (the milling chips) must be disposed of or recycled.

The object of the invention is thus to overcome the disadvantages of the prior art. In particular, an opportunity should be found, or a prosthesis base blank and a method must be provided, with which the simplest possible, complete and low-cost processing of the prosthesis base blank or the simplest possible, complete and low-cost production of the prosthesis base is possible. The milling head or the tool for implementing the subtractive CAM method should here be subject to as little wear as possible. Additionally, the production of the prosthesis base should be completed as quickly as possible. At the same time, the prosthesis base to be produced should be adaptable to the anatomical conditions for different patients.

The objects of the invention are attained by means of a form for producing a pre-molded prosthesis base blank, wherein the pre-molded prosthesis base blank is provided for producing a prosthesis base for a dental prosthesis with a subtractive CAM method, wherein the form features an inner surface which is a negative of the prosthesis base blank to be produced, wherein the inner surface features a negative of a dental arch or a dental arch section with a thickening in the occlusal direction, and the form consists of at least two parts, which are affixed in such a manner that are detachable from each other or which are detachably affixable to each other.

Unlike the standard concept, here a dental arch is regarded not as being the arch of the prosthetic teeth, but the portion of the prosthesis which is formed on the jaw bridge, and which reproduces the gum in which the prosthetic teeth are to be affixed.

The thickening in the occlusal direction is necessary in order to be able to form the papillae between the contact surfaces for the prosthetic teeth in the prosthesis base blank. Since the prosthetic teeth must be inserted individually at different places for each patient, the prosthetic base blank formed with the form according to the invention offers sufficient space or material in order to be able to form the papillae (the areas of the prosthesis for the gum between the teeth) at any point required. According to the invention, the thickening is applied in the occlusion direction on the dental arch or on the dental arch section.

The fact that a negative of the dental arch or dental arch section is contained in the form means that the form creates a receptacle, so that the material for the dental arch to be produced of the prosthesis base blank, or for the dental arch section to be produced of the prosthesis base blank, is already contained in a material thickening when the form is used, or in the prosthesis base blank that is produced with the form. In addition, the measurements of the dental arch or dental arch section are larger than a group of typical dental arches to be produced of prosthesis bases, including the usual tolerances. The dental arch comprises the dental arch of the prosthesis base but not the prosthetic teeth to be inserted. After the prosthetic teeth have been inserted, the set of teeth that has been produced with a prosthesis base blank produced from such a form can therefore be higher than the thickening of the dental arch of the unprocessed prosthesis base blank.

With a form according to the invention, it can also be provided that the inner surface of the form can be adapted by replacing parts, wherein the parts that can replace each other feature a varying partial area of the inner surface of the form for the production of different prosthesis base blanks.

As a result, the form is suitable as a set of parts for producing different prosthesis base blanks, which as a result are already adapted to certain form types for prosthesis bases.

Further, it can be provided that the form features several replaceable parts and/or inserts that can be inserted within the form, which change the inner surface when the parts and/or inserts are used to compile the form.

As a result, a high degree of variability of the form is achieved, and an even more precise adaptation of the prosthesis base blank to the patient's situation is possible. In precise terms, the form then creates a set of parts of differently compilable forms. If necessary, prosthesis base blanks can be produced in different size ranges.

For simpler processing with existing CAM devices, it can also be provided that the inner surface of the form next to the dental arch or dental arch section, also defines bridges and a retaining fixture for the prosthesis base blank, wherein the bridges connect the retaining fixture with the dental arch.

With such a retaining fixture, the prosthesis base blank can be tensioned in CAM-controlled mills or other devices for the subtractive production of prosthesis bases. Preferably, the inner surface of the form is shaped in such a way that with the prosthesis base blank produced with the form, the retaining fixture is solely connected with the dental arch or dental arch section via the bridge.

In one embodiment of the form, which is suitable for producing a retaining fixture as part of the prosthesis base blank, it can be provided that the retaining fixture, which is defined by the inner surface of the form, creates a ring around the dental arch or dental arch section to be produced, wherein preferably, the dental arch or dental arch section is connected to the ring via at least three bridges.

As a result, the prosthesis base blank can be used with the standard retaining fixtures for round blanks. The use of at least three bridges has the advantage that sufficient stability of the dental arch or dental arch section is produced in the ring, so that the dental arch or dental arch section cannot turn against the ring when subject to mechanical stress during processing of the prosthesis base blank. Theoretically, the same effect can also be achieved by two or even just one sufficiently broad bridge. At least three more compact bridges are however preferred according to the invention, since the bridges can then be separated more easily and, the post-processing when removing the bridge attachments from the separated prosthesis base blank is also easier. The diameter of the bridges should be kept as small as possible in order to keep the complexity of post-processing as low as possible.

Further, it can be provided that the at least two parts of the form lie in contact on each other in a perfect fit in at least one join plane, wherein all the bridges to be produced by the form are arranged in the at least one join plane of the form.

This prevents the prosthesis base blank from binding with the form in a non-detachable manner via the inner surface, in particular at those points which are intended to form the bridges. When the form is compiled from three parts, these are placed adjacent to each other on two join planes. When the form is compiled from four parts, these are placed adjacent to each other on two or three join planes. With more parts, more join planes are possible accordingly. The join planes do not need to be arranged geometrically on a flat plane. Instead, the join plane can also be a corrugated, skewed, broken off, arched and/or bent plane.

With a further embodiment of the form according to the invention, it is recommended that the inner surface of the form defines a recess or protrusion which can be used as a reference mark to determine the orientation of the prosthesis base blank, wherein preferably, the inner surface of the form defines a recess or a protrusion on the retaining fixture, in particular on the ring.

With this measure, the orientation of the prosthesis base blank can be determined and defined in a fully automatic manner. This is helpful, since the prosthesis base blank is already pre-molded and can thus only be advantageously processed in a certain position and orientation, or in an area narrowly around this position and orientation.

According to the invention, preferred forms can be characterized by the fact that the form consists of metal, silicon or doubling gel, preferably of metal, particularly preferably of steel, aluminum or brass.

These materials are well suited for producing the prosthesis base blanks. Metallic forms are preferred, since they can be re-used particularly well.

It is also recommended with the invention that the inner surface of the form is coated.

As a result, improved detachability of the hardened or finished prosthesis base blank from the form or its parts can be achieved. The coating can be firmly bonded to the inner surface of the form, or be re-applied before each production of a prosthesis base blank. As an alternative to the coating, the surface can have a very low degree of surface roughness, which can be produced for example through an electropolishing process.

According to a further development, it can also be provided that at least two parts are adjoined to each other along a transversal plane or can be joined to each other.

As a result, a simple demolding of the prosthesis base blank can be achieved. This applies in particular when bridges for binding the dental arch or dental arch section are provided, and these are also arranged on the transversal plane. Here, the transversal plane is a plane in which the jaw arch of the prosthesis base blank to be produced lies.

In order to simplify the manufacture of the prosthesis base blanks, it can further be provided that the inner surface of the parts of the form does not create a geometric body, which, when the prosthesis base blank is demolded, prevents the detachment of the form from the hardened prosthesis base blank, wherein preferably, no undercutting or undercut areas in the inner surface of the parts of the form are provided.

As a result, it can be ensured that the parts of the form are non-destructive, and can be detached from the hardened prosthesis base blank largely without mechanical stress on the prosthesis base blank.

The objects that form the basis of the present invention are also attained by means of a method for producing a prosthesis base blank with a form according to the invention, in which a hot polymer or cold polymer is filled into the at least dual-part compiled form, the hot polymer or cold polymer is then hardened, and as a next step, the parts of the form are detached from the hardened prosthesis base blank.

Here, it can be provided that the prosthesis base blank is deburred at least in sections after the parts of the form have been detached.

Preferably, hardening occurs under increased pressure in order to avoid bubbles in the material.

Further, it can be provided that a hot polymer is filled into the at least two-part compiled metal form using press and pack technique or injection technique.

Alternatively, it can be provided that a cold polymer is filled into the at least two-part compiled metal, silicon or doubling gel form using pouring technique or injection technique.

One method can feature the following method steps for the production of a prosthesis base for the production of a total dental prosthesis or at least a partial dental prosthesis with a prosthesis base blank:
1) Affixing the prosthesis base blank in a CAM device for removing material of the prosthesis base blank using CAM method, and
2) removing the material of the prosthesis base blank with the CAM device on the basis of a calculated CAD model.

From the prosthesis base blank produced according to the invention, either a total prosthesis can be milled or formed for part of a jaw, or several partial prostheses can be milled or formed from a prosthesis base blank.

With the method according to the invention, it is also recommended that the form, the parts of the form and/or inserts of the form to produce the prosthesis base blank are selected from a plurality of forms, parts and/or inserts, wherein the selection is made analytically on the basis of the CAD model of the prosthesis base to be produced and the known dimensions of all forms, parts of the forms and inserts of the forms, wherein preferably, via an output facility of a computer, all possible forms and/or compilations of the parts of the forms and/or compilations of the inserts of the forms are recommended as a selection, and/or can be selected via an input facility.

Further, according to the invention it can also be provided that the form is selected or the combination of parts and/or inserts of a form is selected from the quantity of forms, parts and/or inserts the inner surface of which can fully hold the outer dimensions of the prosthesis base to be produced, which is calculated by the CAD model, wherein preferably, the recommended sequence, in particular the sequence shown or displayed, of the selected forms, parts and/or inserts, is determined by the volume difference between the inner surface of the compiled forms, parts and/or inserts and the CAD model of the prosthesis base to be produced.

It can also be provided according to the invention that the form or combination of parts and/or inserts of a form is automatically recommended or used which has the lowest volume difference from the CAD model of the prosthesis base to be produced.

The objects that form the basis of the invention are further attained by a prosthesis base blank produced with a method according to the invention, or produced with the aid of a form according to the invention.

Here, it can be provided that the prosthesis base blank features bridges which are connected to a ring as a retaining fixture, and which hold the dental arch or dental arch section in the interior of the ring.

With prosthesis base blanks according to the invention, a certain room for play remains in order to be able to produce different prosthesis bases from the prosthesis base blank. It is sufficient when the position of the prosthesis base to be produced is precise to a degree of 10 mm in the prosthesis base blank, preferably 5 mm, and the orientation of the prosthesis base to be produced is precise in the prosthesis base blank to a degree of 10°, preferably 5°. The orientation here relates to possible tilt angles of the prosthesis base to be produced relative to the pre-molded prosthesis base blank.

It can be provided according to the invention that the prosthesis base blank features precisely one symmetry plane or two symmetry planes that are oriented vertically to each other, wherein precisely one symmetry plane is preferred. Preferably, it can here be provided that the one symmetry plane or one of the symmetry planes corresponds to the sagittal plane of the prosthesis base to be produced.

It can also be provided according to the invention that on the side to be placed onto the gum, the prosthesis base blank features an arched depression as a pre-molded form of a mount for a toothless jaw bridge or part of a toothless jaw bridge, wherein the depression runs along the dental arch or dental arch section.

Further, it can be provided that the prosthesis base blank is produced from polymethyl methacrylate (PMMA), polyether ketone (PEK), polyether ether ketone (PEEK), polyamide (PA), polycarbonate (PC) or polyurethane (PU) or a combination of these, or from materials of a combination of said materials. These materials are particularly well-suited for processing the prosthesis base blank with CAM methods. Additionally, aesthetically suitable prosthesis bases can be produced from them.

The invention is based on the surprising finding that, with the form, it is possible in a simple manner to produce a compact prosthesis base blank, the outer dimensions and geometry of which are already adapted to the outer dimensions and geometry of the prosthesis base to be produced from the prosthesis base blank, so that from the prosthesis base blanks produced with the form or the method, the desired prosthesis bases can be quickly produced, removing only small quantities of the material.

In this way, with the pre-molded prosthesis base blanks, it is thus possible to enable a faster and more efficient method for producing prosthesis bases, in which the tools of the CAM device are protected and material loss can be minimized by the subtractive CAM method. Using the suitable form, the prosthesis base blanks remain sufficiently flexible in order to adapt them to the various mouth situations of different patients and to adapt them to the other requirements for the prosthesis base to be produced.

The method and the prosthesis base blanks produced with the form are intended for processing with CAD/CAM methods, and are particularly suitable for this purpose.

The solution approach that forms the basis of this invention preferably assumes various forms or parts and inserts for forms for producing different pre-molded prosthesis base blanks, which eliminate the disadvantages described above due to the fact that they are not full bodies or full discs, but pre-molded blanks. The invention stands out in the fact that—in a similar way to impression trays—it divides the human jaw into categories or sizes on the basis of anatomical features, and provides largely pre-molded prosthesis base blanks accordingly. When different replaceable parts of the forms are used, the prosthesis base blank to be produced can already be adapted to a certain degree to the mouth situation or to the type of patient, and thus the quantity of material to be removed can be further reduced. The software used in a CAD-CAM system can here select a suitable form or suitable parts of the form for the respective patient situation, and conducts the so-called “nesting” in the pre-molded prosthesis base blanks (the best possible positioning of the virtual form of the prosthesis base to be produced in the prosthesis base blank). The prosthesis base blanks can preferably be produced from different materials, such as plastics or wax.

The advantages of the form according to the invention and the method according to the invention, or prosthesis base blanks produced using such methods and forms, are, for example, the lower milling times, lower quantity of prosthesis base material used, and protection of the milling tools, i.e. a lower degree of wear of the milling tools compared to the use of standard milling blanks.

Exemplary embodiments of the invention will be explained below with reference to six schematically depicted figures, although without thereby restricting the invention, in which:

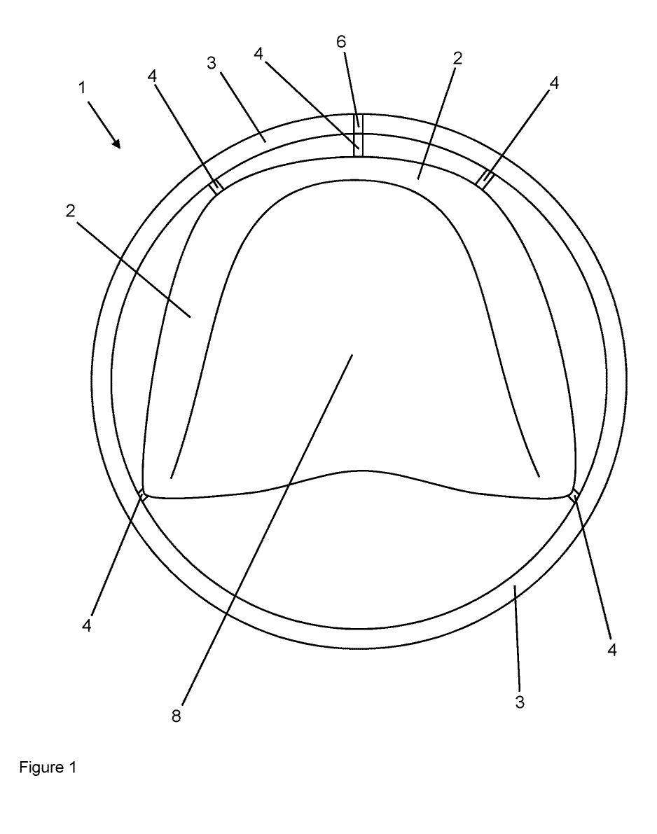

FIG. 1: shows a schematic top view onto a prosthesis base blank according to the invention;

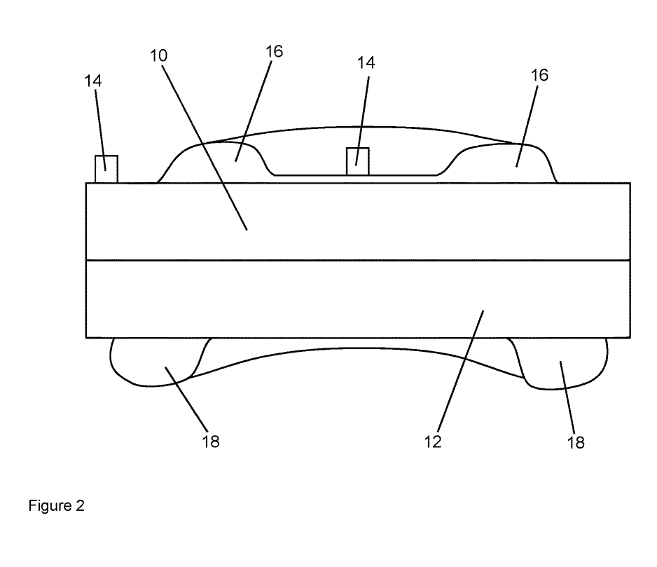

FIG. 2: shows a schematic side view of a form according to the invention for producing a prosthesis base blank;

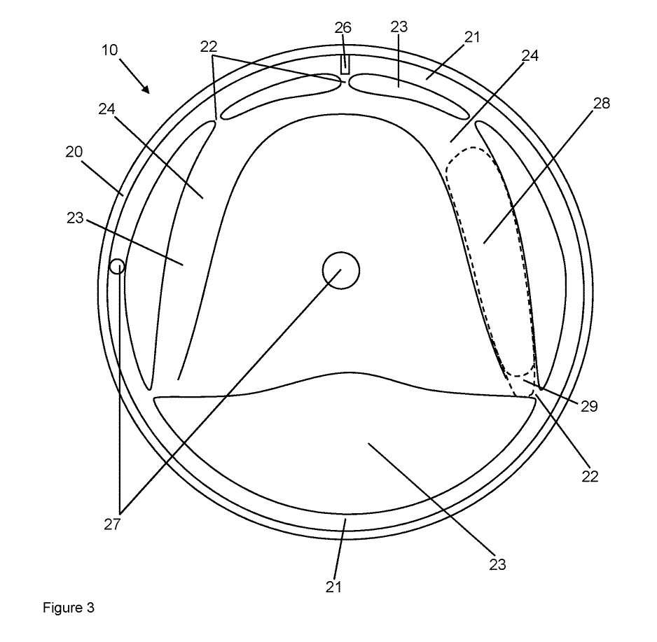

FIG. 3: shows a schematic top view onto the formative surface of a part of the form according to the invention according to FIG. 2;

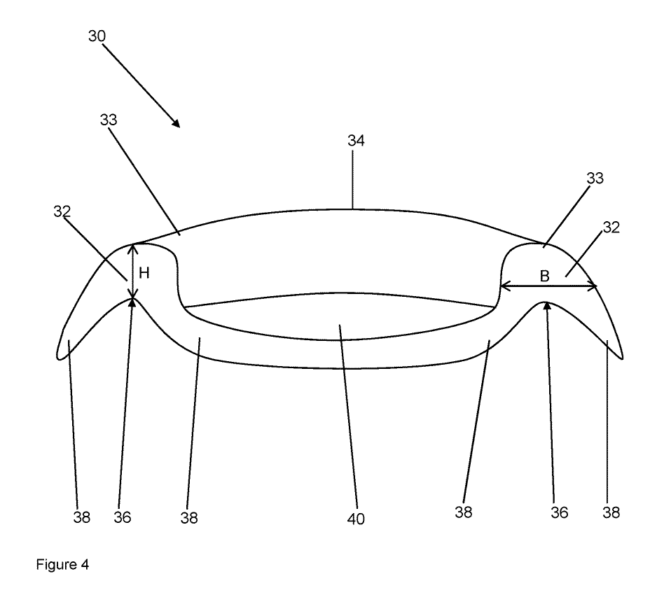

FIG. 4: shows a schematic side view of a prosthesis base blank according to the invention;

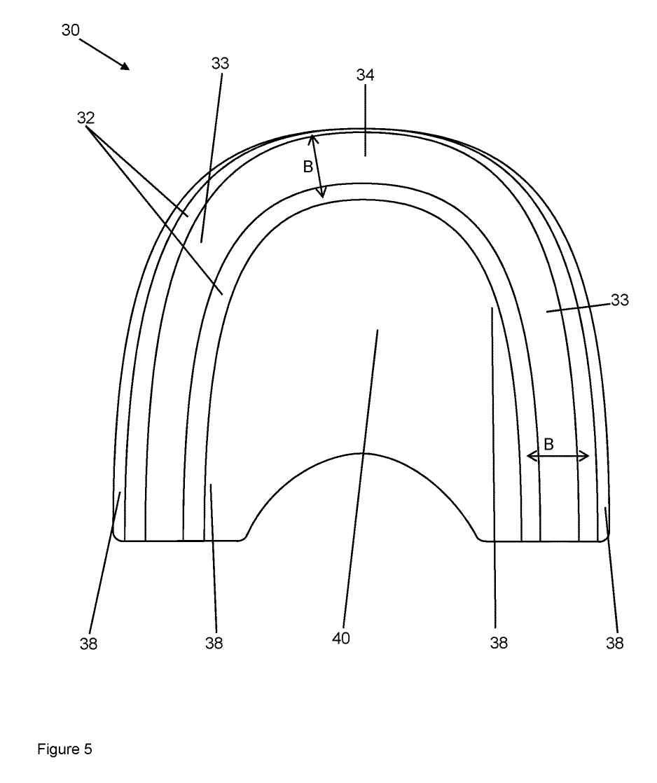

FIG. 5: shows a schematic top view onto a prosthesis base blank according to the invention; and

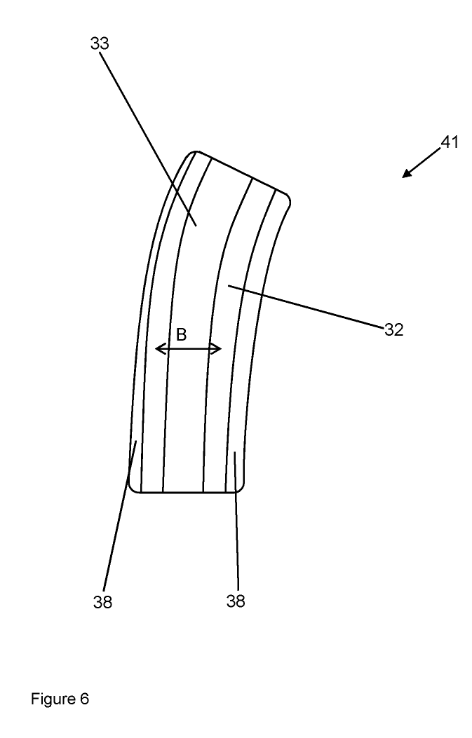

FIG. 6: shows a schematic top view onto a prosthesis base blank according to the invention for a partial prosthesis.

In the figures, in some cases the same reference numerals are also used for the same components with different embodiments.

FIG. 1 shows a schematic top view onto a prosthesis base blank 1 according to the invention, which has been produced using a method according to the invention or a form according to the invention. The prosthesis base blank 1 consists of a plastic, preferably a polymer. On the edge side, the inner area of the prosthesis base blank 1 features a parabolic thickening which forms a pre-molded dental arch 2 with thickening. The prosthesis base blank 1 is symmetrically related to a central plane. This central plane corresponds to the sagittal plane of the patient, in which the dental prosthesis produced with the prosthesis base blank 1 is inserted.

The prosthesis base blank 1 features a ring 3, which surrounds the inner area of the prosthesis base blank 1. The ring 3 is connected with the inner area of the prosthesis base blank 1 via five bridges 4. The ring 3 and the bridges 4 act solely as a retaining fixture for the prosthesis base blank 1 in a standardized retaining fixture of a CAM device, such as a CAM four-axis milling cutter. After processing of the inner area of the prosthesis base blank 1 for the production of the prosthesis base, the bridges 4 are separated and the stumps of the bridges 4 that are created as a result are ground off on the prosthesis base. The prosthesis base is therefore produced only from the inner area of the prosthesis base blank 1 with the pre-molded dental arch 2 and with a palatal plate 8 or a sublingual plate 8.

The vertex of the pre-molded dental arch 2 of a prosthesis base produced from the prosthesis base blank 1 will later be arranged labially, i.e. on the side of the lips, of the patient, if from the prosthesis base blank 1 a total dental prosthesis is produced or a partial prosthesis is produced which comprises at least the central incisor teeth.

The prosthesis base blank 1 shown is suitable both for producing a partial prosthesis base or several partial prosthesis bases, or a total prosthesis base for an upper jaw as well as for a lower jaw. However, it is also possible to produce stronger pre-molded prosthesis base blanks 1 in which a differentiation is made between upper jaw and lower jaw. Additionally or as an alternative, a plurality of different forms can be reserved for the production of different prosthesis base blanks 1, or provided as a set, which differ in terms of the curvature of the dental arches 2 and its width, and from which the correct form for producing a prosthesis base blank 1 can be selected.

FIG. 2 shows a schematic side view of a form according to the invention for producing a prosthesis base blank, comprising two parts 10, 12. The two parts 10, 12 are placed against each other or affixed to each other in such a manner that in the interior of the form, an inner surface is formed which creates a negative of the prosthesis base blank 1 according to FIG. 1 or of another prosthesis base blank. In relation to the prosthesis base blank 1 according to FIG. 1, the inner surface of the form creates the ring 3 on the outer circumference. In the form, at least two filler tubes 14 are provided with openings for filling or pressing or injecting material into the form. The entire material for producing the prosthesis base blank also does not need to be inserted into the form through the filler tubes 14. The form can also or additionally be filled with the material before the two parts 10, 12 are assembled. Also, at least one deaeration opening (not shown) can be included in the forms, in order to enable the air trapped in the form to escape while the material is being pressed in.

The inner surface that creates the dental arch 2 and the elevation or thickening on it can be detected from the outside as a mount 16 for the elevation or thickening in the occlusal direction on the dental arch on the upper part 10 of the form. Also, on the lower side of the lower form 12, mounts 18 can be detected for the inner surface for forming the support on the gum. The form could however equally be constructed cylindrically from the outside.

The two parts 10, 12 of the form are connected to each other on a join plane (the central horizontal line in FIG. 2). On the plane of the join plane, the two parts 10, 12 lie flush with each other with contact surfaces. On the plan of the join plane, all bridges 4 are arranged that are to be formed of the prosthesis base blank 1. As a result, it is achieved that the parts 10, 12 of the form can be separated from the prosthesis base blank 1 when the prosthesis base blank 1 has hardened, and that the parts 10, 12 do not grip into the bridges 4, thus preventing a detachment of the parts 10, 12 from the hardened prosthesis base blank 1. In the contact surfaces, pins and holes (not shown) or tongues and grooves (not shown) can be provided in order to force a clear orientation of the two parts 10, 12 to each other when the parts 10, 12 are affixed to each other.

FIG. 3 shows a schematic top view onto the formative surface of the upper part 10 of the form according to the invention according to FIG. 2. The part 10 of the form has an edge 20 which encloses the entire part 10 of the form. The edge 20 forms a surface which lies on a matching counter piece, i.e. on a matching edge of the part 12, and concludes the form on the exterior. Directly next to the edge 20, a negative form for the ring 21 is located, i.e. the area of the inner surface of the form which is provided for shaping the ring 3 according to FIG. 1. Adjacent to this are the negative forms for the bridges 22, which are arranged between five contact surfaces 23. The negative forms for the bridges 22 are accordingly the area of the inner surface of the form which is provided for shaping the bridges 4 according to FIG. 1. The five contact surfaces 23 lie in a compiled state of the form on the corresponding and precisely fitting contact surfaces of the other part 12 of the form. The contact surfaces 23 and the area of the ring 21 all lie on the join plane of the form. Here, the contact surfaces 23 can theoretically have a different height to the surface of the ring 21. The join plane would then be arched accordingly or at least be not level, and could then also be geometrically more correctly described as a join surface.

Adjacent to the front four contact surfaces 23 (in FIG. 3 above), a negative form for the dental arch 24 lies inwardly adjacent, with the elevations or thickenings. The negative forms for the bridge 24 are the area of the inner surface of the form which is provided for shaping the dental arch 2 according to FIG. 1. On the front side of the part 10 of the form, a negative form is provided for the marking 26. The negative forms for the markings 26 are accordingly the area of the inner surface of the form which is provided for shaping the bridges 6 according to Figure

In the center and next to the edge 21 of the part 10 of the form, openings 27 are provided for filling material for producing the prosthesis base blank 1 according to FIG. 1 or another prosthesis base blank. These openings 27 open into the filler tubes 14 according to FIG. 2.

An insert 28 can be inserted into the negative form for the dental arch 24 and preferably affixed, with which an inner surface can be produced which deviates from the part 10 of the form. The insert 28 features a thickening 29 in some areas for this purpose. The insert 28 is shown in FIG. 3 by broken lines, which are intended to indicate that this is a separate, detachable additional piece of the form. When the insert 28 is used, it is affixed in the negative form for the dental arch 24 and as a result, the inner surface of the form changes in this area. As a result, the prosthesis base blank which is produced with the thus modified form is less thick in this area, i.e. features less material and if necessary, can also be shorter due to the thickening 29. Consequently, the prosthesis base blank can be adapted to the mouth situation of the patient.

In the same way, another part can also be used from a plurality of parts of a form in order to replace the part 10 and/or the part 12. Additionally, the prosthesis base blank produced with the form can consequentially be adapted to the mouth situation of the patient.

FIG. 4 shows a schematic side view of a prosthesis base blank 30 according to the invention, which has been produced with a form according to the invention, such as a form according to FIGS. 2 and 3, or with a method according to the invention. The prosthesis base blank 30 comprises, in the same way as shown in FIG. 1, a dental arch 32, to which a breadth B can be assigned. The dental arch 32 extends on the edge side in a parabolic form along the prosthesis base blank 30. The dental arch 32 features a thickening 33 in the occlusal direction, which provides sufficient space for forming papillae in the prosthesis base. In the area of a vertex 34 of the prosthesis base blank 1, the height H of the dental arch 32 is somewhat more strongly enlarged.

On the underside of the prosthesis base blank 30, a depression 36 is provided (in FIG. 4 below) which serves as a pre-molding of a contact surface of the toothless gum of the patient in the prosthesis base to be produced. To the side next to the dental arch 32, broadenings 38 or protrusions 38 are provided, from which a connection surface to the jaw bridge of the patient can be formed.

With this embodiment of the prosthesis base blank 30, a center piece 40 extends through to the center, so that from this prosthesis base blank 30, a large-surface palatal cover can also be formed.

FIG. 5 shows a schematic top view onto a further prosthesis base blank 30 according to the invention. The prosthesis base blank 30 features rounded corners in order to prevent the risk of parts of the prosthesis base blank 30 breaking off during processing. Such rounded edges can be provided for all prosthesis base blanks 1, 30 according to the invention.

The prosthesis base blank 30 features a parabolic thickening on the edge side in the form of a dental arch 32, which in a similar way to the embodiments shown in FIG. 4 extends upwards (in FIG. 5 in the direction of the observer) and there forms a thickening 33 in the occlusal direction. In the area of the vertex 34 of the dental arch 32, the height of the dental arch 32 or the thickening 33 can be greater than on the other areas of the dental arch 32. With the embodiment according to FIG. 5, the breadth B is also somewhat increased in the area of the vertex 34.

Next to the dental arch 32, protrusions 38 are provided which serve the same purpose as the protrusions 38 shown in FIG. 4. In the center of the prosthesis base blank 30, a center piece 40 is provided, from which a palatal plate or sublingual support of the prosthesis base to be produced can be created. In the area of the vertex 34 of the prosthesis base blank 30, the labial protrusion 38 is strongly reduced or no longer present. The profile of the dental arch 32 vertical to the parabolic curve or vertical to the dental arch 32 changes along the dental arch 32. The inclination of the labial flank of the dental arch 32 is reduced in the area of the vertex 34.

The prosthesis base blanks 30 according to FIGS. 4 and 5 are all symmetrical with regard to the sagittal plane in which the vertex 34 is located. Any asymmetries required for anatomical reasons can be produced when the prosthesis base blank 30 is milled out during production of the prosthesis base, or produced through additional parts of the form or inserts of the form.

A method according to the invention will be described below with reference to FIGS. 1 to 5.

In order to produce a prosthesis base, a prosthesis base blank 1, 30 is created with a form, wherein the parts 10, 12 and if necessary, the inserts 28 of the form are selected from a plurality of parts and if necessary, inserts, of different surfaces. Here, the inner surface 24 of the form that is suitable is determined using a computer-supported method. The possible inner surfaces 24 of the different forms are stored electronically for this purpose in a database. The mouth situation of the patient to be treated is scanned in and digitalized with the aid of a 3D scanner. On the basis of this and, if necessary, additional data, a virtual model of the prosthesis base to be produced is created with the aid of a CAD method.

A test is then conducted the existing possible inner surface of the form in which or into which the prosthesis base to be produced might fit. A list of the possible prosthesis base blanks 1, 30 is offered on a screen of a computer. The sequence can depend on the volume difference between the prosthesis base to be produced and the inner surface 24 of the form, wherein lower volume differences are favored. Alternatively, only the form with the lowest volume difference can be shown. The low volume difference has the advantage that with prosthesis base blanks 1, 30 produced using these forms, less material needs to be removed than with prosthesis base blanks 1, 30 with a higher volume difference in relation to the prosthesis base to be produced.

As a next step, a form with the matching parts 10, 12 and if necessary with matching inserts 28 is selected by the user or by the computer, and all parts 10, 12 and, if necessary, inserts 28 are compiled. The compiled form is filled or pressed with a plastic that can be hardened, and the plastic hardens in the form. The parts 10, 12 and, if necessary, the inserts 28 are detached from the prosthesis base blank 1, 30 that has been produced and hardened in this manner. If necessary, burrs are removed. The detached prosthesis base blank 1, 30 is tensioned in a CAM device, such as a CAM four-axis milling cutter. Here, it must be ensured that the orientation of the prosthesis base blank 1, 30 in the CAM device is correct. For this purpose, markings 6 or recesses can be provided on the prosthesis base blank 1, 30, which enable or preferably force a certain position and orientation of the prosthesis base blanks 1, 30 in the CAM device.

As a next step, on the basis of the CAD model of the prosthesis base to be produced, said prosthesis base is milled out of the tensioned prosthesis base blank 1, 30 or produced using another subtractive CAM method.

In this prosthesis base, recesses or surfaces for holding prosthetic teeth can also be produced. As a next step, the prosthetic teeth are glued into the prosthesis base and the dental prosthesis is complete.

FIG. 6 shows a schematic top view of a prosthesis base blank 41 according to the invention for a partial prosthesis. The prosthesis base blank 41 is in principle a part of the prosthesis base blank 30 according to FIG. 5 on the molar side. A dental arch section 32 is provided in the form of a parabolic section as a thickening 33 of the material of the prosthesis base blank 41. Since the breadth B of the prosthesis base blank 41 is almost as wide as the entire profile of the prosthesis base blank 41, the dental arch 32 is also arranged on the edge side with this embodiment. Next to the dental arch 32, short protrusions 38 are provided which serve the same purpose as the protrusions 38 of the exemplary embodiments shown in FIGS. 4 and 5.

On the underside of the prosthesis base blank 41, a depression can be provided (not visible in the top view according to FIG. 6), which extends below the thickening 33 of the dental arch 32 in the same direction and position. The depression serves as a pre-mold of the later contact surface on the gum of a partial prosthesis base produced from the prosthesis base blank 41, or of the partial dental prosthesis produced from it.

The method of production for the prosthesis base blank 41 according to FIG. 6 runs similarly to the methods depicted in FIGS. 1 to 5, wherein only one partial dental prosthesis is of course produced.

According to the invention, the prosthesis base blanks 30, 41 according to FIGS. 4 to 6 preferably feature bridges (not shown) and a ring (not shown), as is shown in FIG. 1. The ring surrounds the pieces of the prosthesis base blank 30, 41 shown in FIGS. 4 to 6, and is arranged on the transversal plane. The ring can be used as a retaining fixture for a CAM milling cutter. Additionally, a mark (not shown in FIGS. 4 to 6) is preferably provided on the ring, with which the orientation and position of the prosthesis base blank 30, 41 can be determined in the CAM milling cutter. The ring and the bridges are not shown in FIGS. 4 to 6 merely for purposes of clarity, although they are particularly preferred for the implementation of the present invention.

The features of the invention disclosed in the above description, and in the claims, figure and exemplary embodiments, can be essential both individually and in any combination required for the realization of the invention in its different embodiments.

List of reference numerals

1, 30 Prosthetic base blank

2, 32 Pre-molded dental arch

3 Ring

4 Bridge

6 Mark

8 Palatal plate/sublingual plate

10 Molded part

12 Molded part

14 Filler tubes

16 Mount for the occlusal elevation on the dental arch

18 Mount for support on gum

20 Edge

21 Negative form for ring

22 Negative form for bridge

23 Contact surface

24 Negative form for dental arch

26 Negative form for mark

27 Filling opening

28 Insert

29 Thickening

33 Palatinal thickening

34 Vertex of the dental arch

36 Depression on the contact surface to the gum

38 Protrusion

40 Center piece

41 Prosthesis base blank for partial prosthesis

B Breadth of the dental arch

H Height of the dental arch

1. A form for producing a pre-molded prosthesis base blank, wherein the pre-molded prosthesis base blank is provided for producing a prosthesis base for a dental prosthesis with a subtractive CAM method, wherein the form features an inner surface which is a negative of the prosthesis base blank to be produced, wherein the inner surface features a negative of a dental arch or a dental arch section with a thickening in an occlusal direction, and the form consists of comprises at least two parts, which are affixed in such a manner that they are detachable from each other or which are detachably affixable to each other.

2. The form according to claim 1, wherein the inner surface of the form can be adapted by replacing parts, wherein the parts that can replace each other have a different partial area of the inner surface of the form for producing different prosthesis base blanks.

3. The form according to claim 1, characterized in that wherein the form includes several replaceable parts and/or inserts that can be inserted within the form and which change the inner surface when the parts and/or inserts are used to compile the form.

4. The form according to claim 1, wherein the inner surface of a form adjacent the dental arch or dental arch section additionally defines bridges and a retaining fixture for the prosthesis base blank, wherein the bridges connect the retaining fixture with the dental arch.

5. The form according to claim 4, wherein the retaining fixture which is defined by the inner surface of the form creates a ring around the dental arch or dental arch section to be produced.

6. The form according to claim 4, wherein the at least two parts of the form lie in contact on each other in a perfect fit in at least one join plane, wherein all the bridges to be produced by the form are arranged in the at least one join plane of the form.

7. The form according to claim 1, wherein the inner surface of the form defines a recess or protrusion which can be used as a reference mark to determine an orientation of the prosthesis base blank.

8. The form according to claim 1, wherein the form comprises metal, silicon, or doubling.

9. The form according to claim 1, wherein the at least two parts are joined to each other or are to be joined to each other along a transversal plane.

10. The form according to claim 1, wherein the inner surface of the parts of the form does not create a geometric body, which, when the prosthesis base blank is demolded, prevents the detachment of the form from the hardened prosthesis base blank.

11. A method for producing a prosthesis base blank with a form according to claim 1, the method comprising filling a hot polymer or a cold polymer into the at least two-part compiled form, then hardening the hot polymer or the cold polymer, and as a next step, detaching the parts of the form from the hardened prosthesis base blank.

12. The method according to claim 11, comprising deburring the prosthesis base blank is deburred at least in sections after the parts of the form have been detached.

13. The method according to claim 11, comprising filling a hot polymer into the at least two-part compiled metal form using a press and pack technique or an injection technique.

14. The method according to claim 11, comprising filling a cold polymer into an at least two-part compiled metal, silicon, or doubling gel form using a pouring technique or an injection technique.

15. A prosthesis base blank produced using a method according to claim 11.

16. The prosthesis base blank according to claim 15, wherein the prosthesis base blank includes bridges which are connected to a ring as a retaining fixture, and which hold the dental arch or dental arch section in the interior of the ring.

17. The form according to claim 5, wherein the dental arch or dental arch section is connected to the ring via at least three bridges.

18. The form according to claim 7, wherein the inner surface of the form defines a recess or a protrusion on the retaining fixture.

19. The form according to claim 18, wherein the inner surface of the form defines a recess or a protrusion on the ring.

20. The form according to claim 8, wherein the form comprises metal.

21. The form according to claim 20, wherein the form comprises steel, aluminum or brass.

22. The form according to claim 10, wherein no undercutting or undercut areas in the inner surface of the parts of the form are provided.

23. A prosthesis base blank with the aid of a form according to claim 1.

24. The prosthesis base blank according to claim 23, wherein the prosthesis base blank includes bridges which are connected to a ring as a retaining fixture, and which hold the dental arch or dental arch section in the interior of the ring.
